(19) United States
(12) Patent Application Publication
(10) Pub. No.: US 2024/0239549 A1
(43) Pub. Date: Jul. 18, 2024

(54) Comic Belt

(71) Applicant: Jason Michael Kokotoff, Lake Worth, FL (US)

(72) Inventor: Jason Michael Kokotoff, Lake Worth, FL (US)

(21) Appl. No.: 18/154,289

(22) Filed: Jan. 13, 2023

(51) Int. Cl. B65D 5/50

(52) U.S. Cl. CPC B65D 5/5028

(57) ABSTRACT

The present disclosure is directed to a device used to stabilize the storing of collectable comic books, magazines or other periodicals inside a receptacle that may or may not be designed specifically for the storage of such collectables. The device can be utilized on receptacles that are marketed for the exact purpose of storing collectable periodicals, as well as any other receptacle that allows the device's installation clips to fit over its outer walls. The device can be size adjusted to fit narrow or wide receptacles without puncturing. Once installed, the device prevents periodicals from falling back or forward into the void of a less-than-full receptacle, preventing damage to the condition of the collectibles. The low-profile of the device allows a receptacle's existing lid or cover to be utilized without interference.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A READ-ONLY OPTICAL DISC, AS A TEXT FILE OR AN XML FILE VIA THE PATENT ELECTRONIC SYSTEM

Not Applicable

### STATEMENT REGARDING PRIOR DISCLOSURES BY THE INVENTOR OR A JOINT INVENTOR

Not Applicable

### BACKGROUND OF THE INVENTION

### (1) Field of the Invention

The various aspects discussed herein relate to safe storage of collectible comic books, magazines, or other periodicals in storage receptacles.

### (2) Description of Related Art

There are problems with safely storing collectible comic books, magazines, and other periodicals in storage boxes.

Accordingly, there is a need in the art for a device that helps secure the collectibles' stability, preventing damage.

### BRIEF SUMMARY OF THE INVENTION

The present disclosure is directed to the safe storage of collectible comic books, magazines, or other such periodicals inside of storage receptacles. These receptacles may be manufactured and marketed as specific to the storage of said collectibles or they may be multi-use, generic receptacles used for storing many different types of items. The device can be size adjusted and installed in such receptacles, creating a barrier so the collectibles are secured in an upright position, preventing them from falling backwards or forwards when the storage receptacle is moved. This will prevent the collectibles from falling on themselves, incurring dents, creases or other damage considered detrimental to the collectible's value.

### BRIEF DESCRIPTION OF THE SEVERAL VIEWS OF THE DRAWING(S)

For a better understanding of the embodiments, reference will now be made by way of example to the accompanying drawings. In the drawings, identical reference numbers identify the same or similar elements or acts unless the context indicates otherwise. The sizes and relative proportions of the elements in the drawing are not necessarily drawn to scale. For example, some of these elements may be enlarged and positioned to improve drawing legibility.

FIG. 1 is a front view of an embodiment of a device in its minimum adjustable width that can be installed in a storage receptacle used for collectible periodicals.

FIG. 2 is a front view of an embodiment of a device in its maximum adjustable width that can be installed in a storage receptacle used for collectible periodicals.

FIG. 3 is a back view of an embodiment of a device in its minimum adjustable width that can be installed in a storage receptacle used for collectible periodicals.

FIG. 4 is a back view of an embodiment of a device in its maximum adjustable width that can be installed in a storage receptacle used for collectible periodicals.

FIG. 5 is a front, deconstructed view of the embodiment of the male half of an adjustable width device that can be installed in a storage receptacle used for collectible periodicals.

FIG. 6 is a front, deconstructed view of the embodiment of the female half of an adjustable width device that can be installed in a storage receptacle used for collectible periodicals.

FIG. 7 is a back, separated view of the embodiment of the male and female halves of an adjustable width device that can be installed in a storage receptacle for collectible periodicals.

### DETAILED DESCRIPTION OF THE INVENTION

In the following description, certain specific details are set forth in order to provide a thorough understanding of various embodiments of the disclosure. However, one skilled in the art will understand that the disclosure may be practiced without these specific details. In other instances, well-known structures associated with receptacles used for collectible periodical storage have not been described in detail to avoid unnecessarily obscuring the descriptions of the embodiments of the present disclosure.

Unless the context requires otherwise, throughout the specification and claims that follow, the word “comprise” and variations thereof, such as “comprises” and “comprising,” are to be construed in an open, inclusive sense, that is, as “including, but not limited to.”

The use of ordinals such as first, second, third, etc., does not necessarily imply a ranked sense of order, but rather may only distinguish between multiple instances of an act or a similar structure or material.

Reference throughout this specification to “one embodiment” or “an embodiment” means that a particular feature, structure, or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terms “left, “right,” “top, “bottom,” “upper,” or “lower” are used for discussion purposes only based on the orientation of the components in the discussion of the Figures in the present disclosure as follows. These terms are not limiting as the possible positions explicitly disclosed, implicitly disclosed, or inherently disclosed in the present disclosure.

As used in this specification and the appended claims, the singular forms “a,” “an,” and “the” include plural referents unless the content clearly dictates otherwise.

While various embodiments are shown and described with respect to an adjustable width device installed in storage receptacle for collectible periodicals, it will be readily appreciated that embodiments of the present disclosure are not limited thereto. In various embodiments, the structures, devices, methods, and the like described herein may be embodied in or otherwise utilized in any suitable type or form of an adjustable width device installed in a storage receptacle for collectible periodicals.

The present disclosure is directed to embodiments of an adjustable width device that can be installed inside any storage receptacle that is compatible with the device's installation clips.

The installation clips can attach to the walls of the receptacle keeping it in place without puncturing or damaging the storage recepticle, enabling the device to act as a “stop” for any collectible periodcals to stand upright without falling back into the void of the receptacle.

The device can be easily installed and uninstalled anywhere along the entire length of the chosen receptacle as more periodicals are added to the storage receptacle.

The device's width can be adjusted via the adjustment knob on its back, allowing the device to be installed in storage receptacles of various widths, ranging in size from collectible comic books to larger magazines.

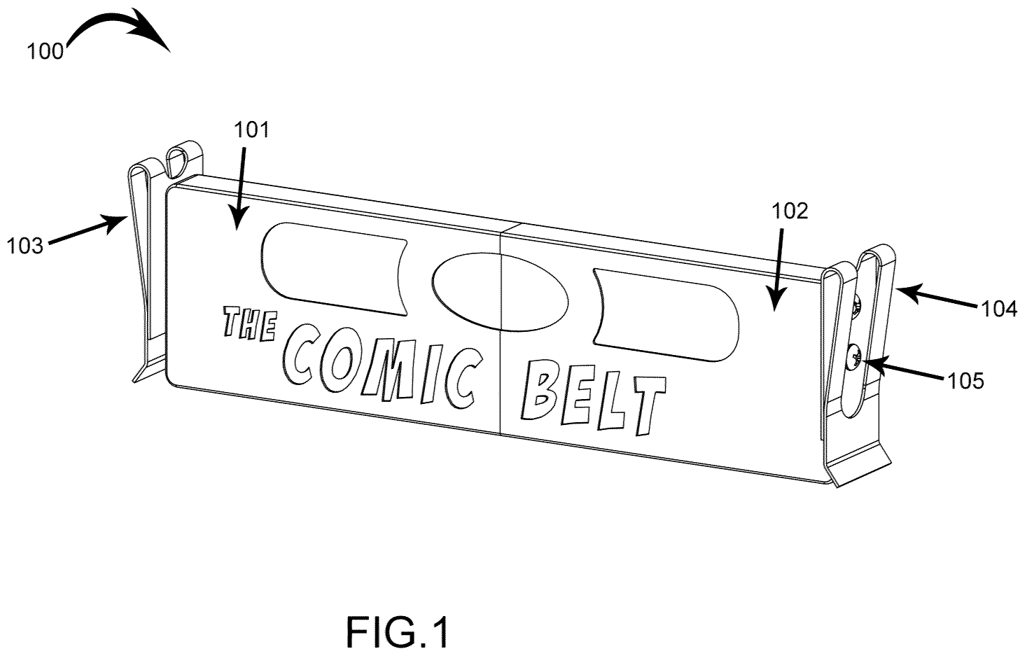

FIG. 1 is a front view of an embodiment of a device in its minimum adjustable width that can be installed in a storage receptacle used for collectible periodicals 100 in which the left and right installation clips 103,104 slide over the walls of the storage receptacle keeping in place the connected male and female halves 101,102 inside the storage receptacle to act as a dam or “stop” for the collectible periodicals inside, allowing them to stand upright without falling back or forward into any void of the less-than-full storage receptacle.

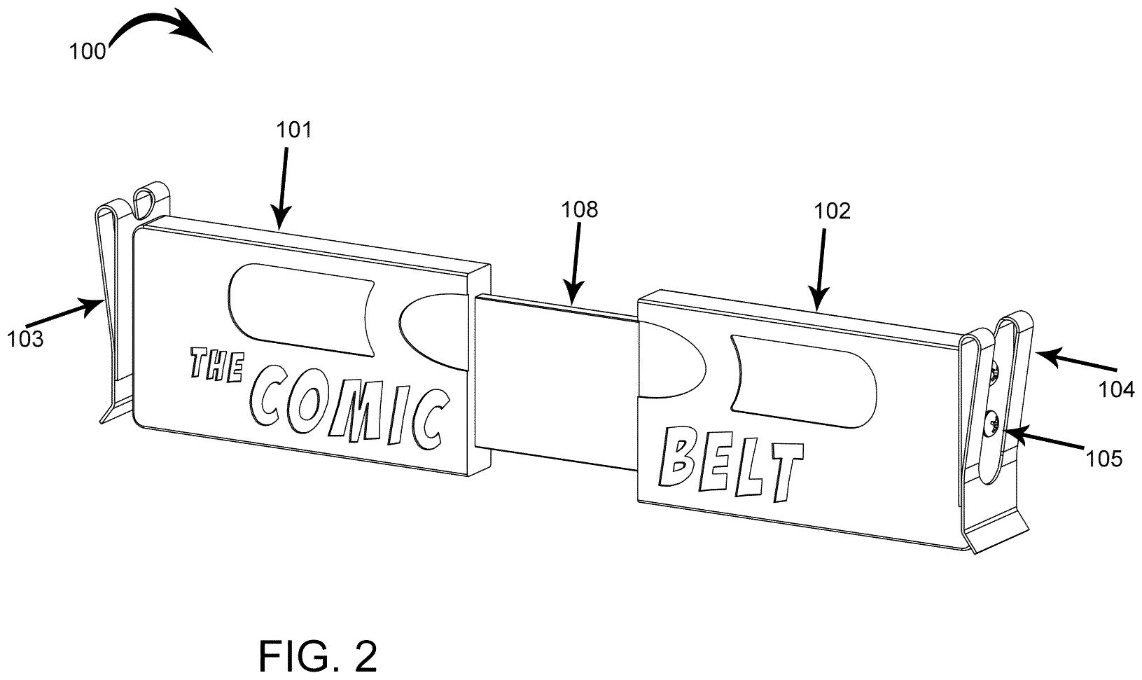

FIG. 2 is a front view of an embodiment of a device in its maximum adjustable width that can be installed in a storage receptacle used for larger, collectible periodicals 100 such as magazines or treasury-sized comic books. The male and female halves 101,102 can pull away from each other revealing the extension tongue 108.

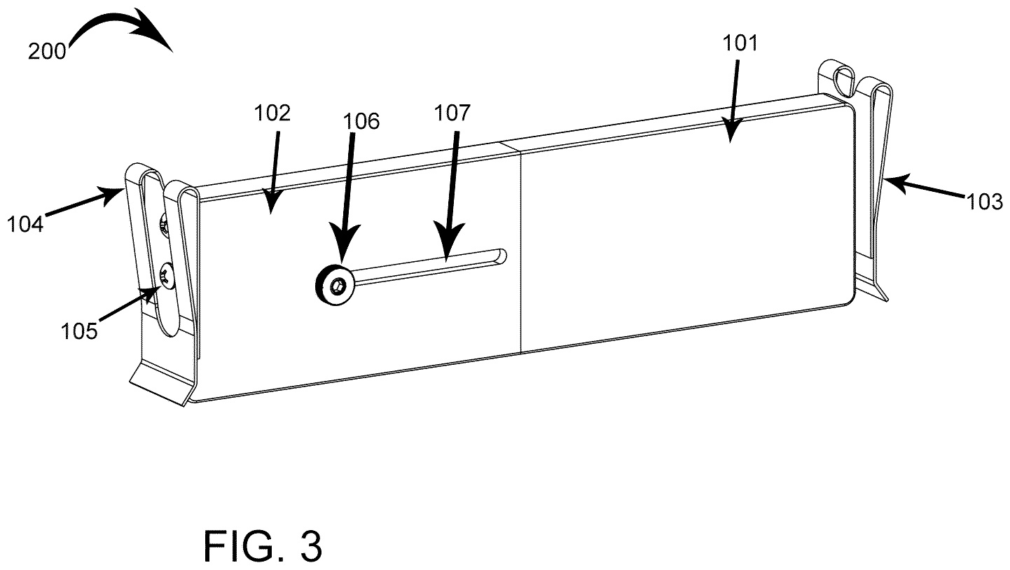

FIG. 3 is a back view of an embodiment of a device in its minimum adjustable width that can be installed in a storage receptacle used for collectible periodicals 200.

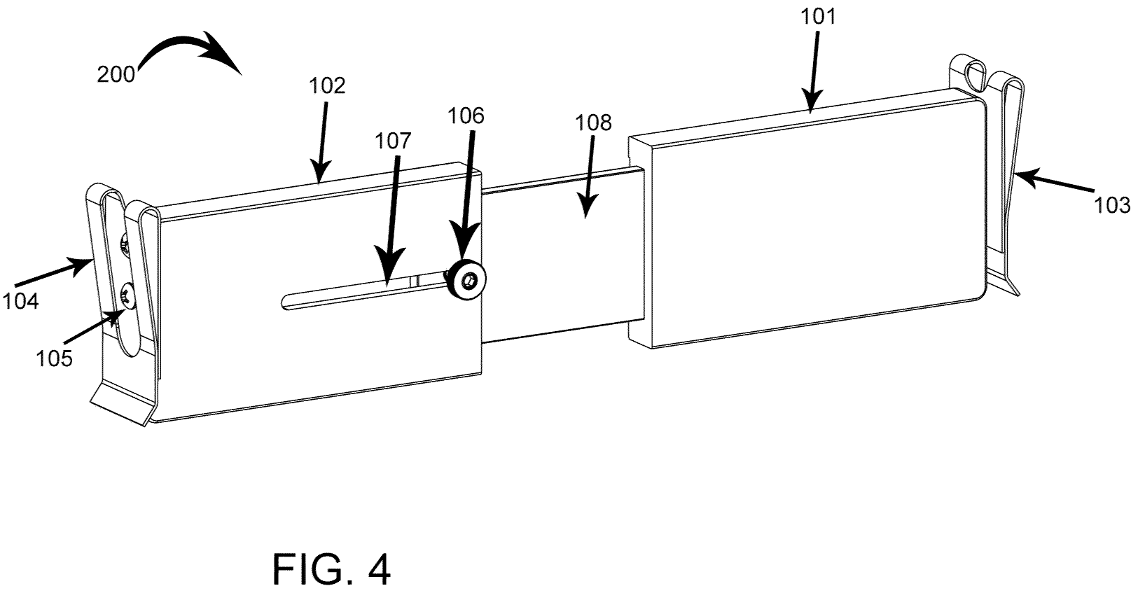

FIG. 4 is a back view of an embodiment of a device in its maximum adjustable width that can be installed in a storage receptacle used for larger, collectible periodicals 200 such as magazines or treasury-sized comic books. The size-adjustment knob 106 can be turned counter-clockwise to loosen the device and allow the male and female halves 101,102 to pull away from each other revealing the extension tongue 108. The size-adjustment knob 106 can then be tightened by turning clockwise anywhere along the sizing track 107 to lock in the desired width of the device.

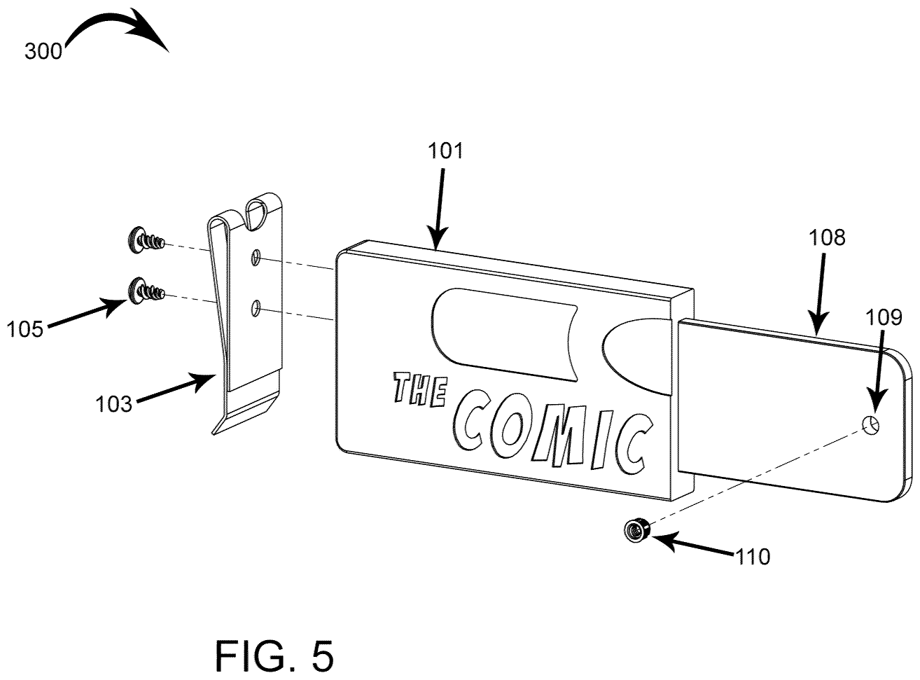

FIG. 5 is a deconstructed view of an embodiment of the male half of the device 300. The left installation clip 103 is adhered to the male half 101 by two round-head thread forming screws 105. The brass, barbed insert 110 is inserted into the extension tongue hole 109.

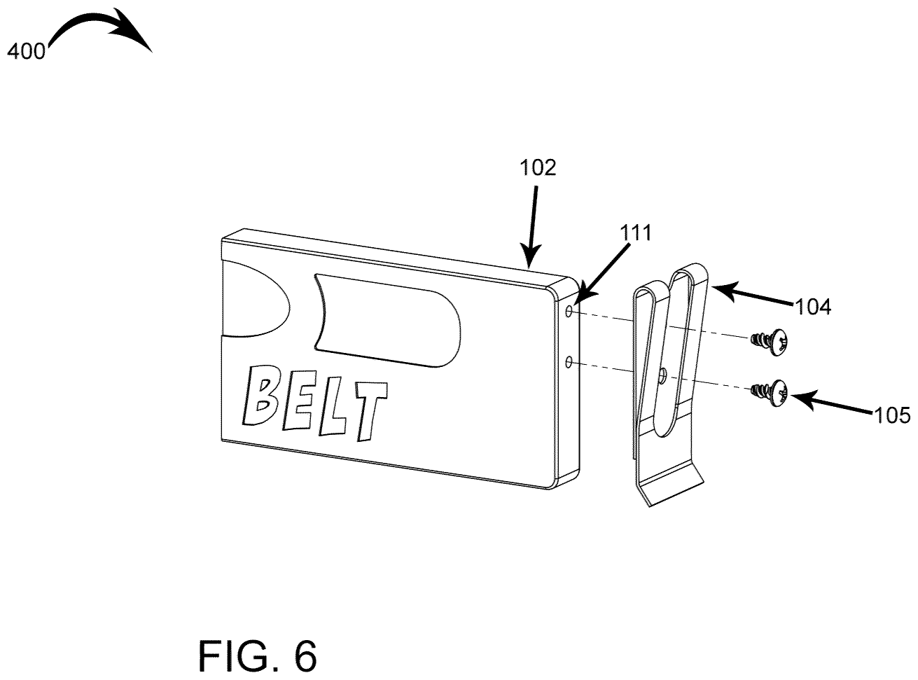

FIG. 6 is a deconstructed view of an embodiment of the female half of the device 400. The right installation clip 104 is adhered to the female half 102 by two round-head thread forming screws 105 which thread into the guide holes 111.

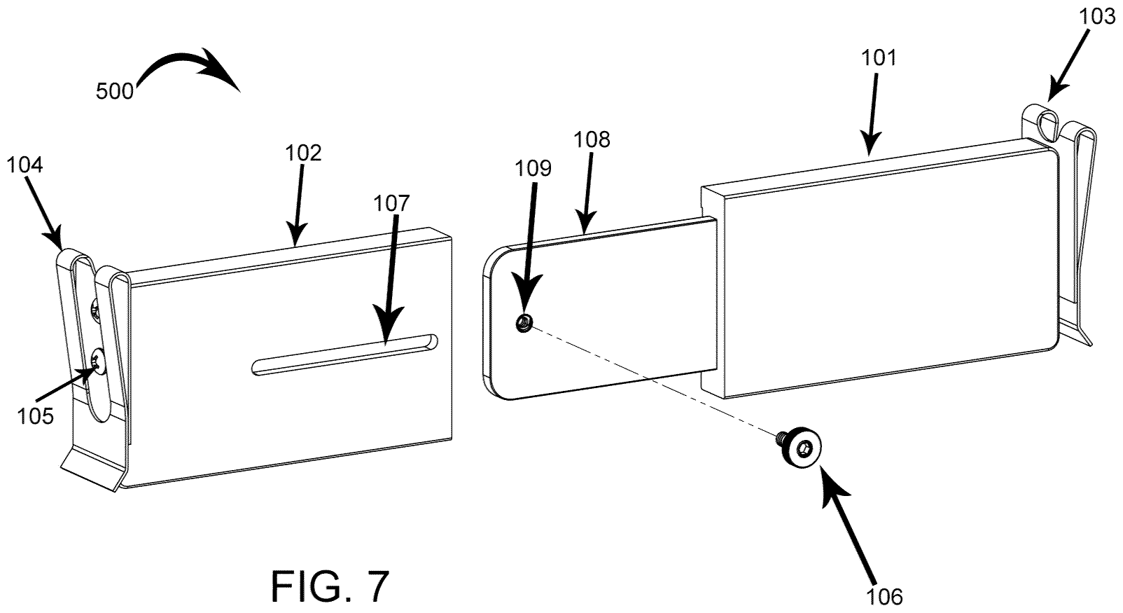

FIG. 7 is a back view of an embodiment of the separated male and female halves 500. The size-adjustment knob 106 is inserted into the extension tongue hole 109 and threaded through the barbed insert 110 after the male half 101 is inserted into the female half 102. The size-adjustment knob 106 can then be tightened by turning clockwise anywhere along the sizing track 107 to obtain the custom size for installation in a storage receptacle.

1. An adjustable sizing device installed in a comic book storage box that does not puncture or damage the box itself and helps to keep the comic books that are being stored, upright and preventing them from falling backwards or forwards, incurring damage.
